(19) United States
(12) Patent Application Publication
(10) Pub. No.: US 2024/0113383 A1
(43) Pub. Date: Apr. 4, 2024

(54) GAS MANAGEMENT FOR METAL-AIR BATTERIES

(71) Applicant: FORM ENERGY, INC., Somerville, MA (US)

(72) Inventors: Jaime Andres OCAMPO, Berkeley, CA (US); Grant FRIESEN, Berkeley, CA (US); Alli NANSEL, Berkeley, CA (US); Sid BANERJEE, Berkeley, CA (US); Danielle Cassidy SMITH, Somerville, MA (US); Ellie PARKER, Berkeley, CA (US); Nicholas MCKIBBEN, Berkeley, CA (US); Aruna MOHAN, Somerville, MA (US)

(21) Appl. No.: 18/352,223

(22) Filed: Jul. 13, 2023

Related U.S. Application Data
(60) Provisional application No. 63/368,348, filed on Jul. 13, 2022.

(51) Int. Cl. H01M 50/358; H01M 10/42; H01M 10/48; H01M 10/6563; H01M 10/6569; H01M 12/08; H01M 50/209

(52) U.S. Cl. CPC H01M 50/358; H01M 10/4228; H01M 10/482; H01M 10/6563; H01M 10/6569; H01M 12/08; H01M 50/209

(57) ABSTRACT

Systems, methods, and devices for gas management of metal-air batteries. Each one of a plurality of electrochemical cells may include at least one air electrode, a metal electrode, a vessel, and a liquid electrolyte between the at least one air electrode and the metal electrode in the vessel, with each one of the plurality of electrochemical cells defining a respective headspace above the liquid electrolyte in the vessel. A manifold may include ducting defining a shared vent and an outlet region, and the respective headspace of each one of the plurality of electrochemical cells may be fluidically coupled to the shared vent and in fluid communication with the outlet region of the ducting.

### CROSS-REFERENCE TO RELATED APPLICATIONS

This application claims the benefit of priority to U.S. Provisional Patent Application No. 63/368,348, filed on Jul. 13, 2022, the entire contents of which are incorporated herein by reference.

### BACKGROUND

Energy storage technologies are becoming increasingly important in electric power grids. For example, energy storage devices may provide smoothing to better match generation and demand on an electric power grid, as may be beneficial to electric power grids across multiple time scales. While energy storage technologies can support timescales from milliseconds to hours, there is a need for increased availability, reliability, and/or resiliency with reduced costs in energy storage systems.

### SUMMARY

Systems, methods, and devices of the various embodiments may include configurations for power systems. Systems and methods of the various embodiments may provide configurations for components of battery systems. Battery systems may include a plurality of electrochemical cells, in which each electrochemical cell includes at least one air electrode, a metal electrode, a liquid electrolyte separating the at least one air electrode from the metal electrode, and a vessel containing the liquid electrolyte. Battery systems may further, or instead, include an airflow system to vent gas from the plurality of metal-air batteries.

According to one aspect, a system for gas management of metal-air batteries, may include a plurality of electrochemical cells, each one of the plurality of electrochemical cells including at least one air electrode, a metal electrode, a vessel, and a liquid electrolyte between the at least one air electrode and the metal electrode in the vessel, each one of the plurality of electrochemical cells defining a respective headspace above the liquid electrolyte in the vessel, and a manifold including ducting defining a shared vent and an outlet region, the respective headspace of each one of the plurality of electrochemical cells fluidically coupled to the shared vent and in fluid communication with the outlet region of the ducting.

In some implementations, the system may further include a plurality of risers, wherein each one of the plurality of risers defines a respective cell vent, and the respective headspace of each one of the plurality of electrochemical cells is fluidically coupled to the shared vent via at least one cell vent of the plurality of risers.

In some implementations, the system may further include at least one fan in fluid communication with the shared vent, wherein the at least one fan is operable to move gas along the shared vent and out of the ducting via the outlet region. The at least one fan may be disposed in the shared vent, for example. Further, or instead, the at least one fan may be oriented relative to the shared vent such that the at least one fan is operable to form negative pressure in the shared vent relative to ambient air pressure at the outlet region of the ducting. The at least one fan is explosion-proof rated in some instances. Further, or instead, the at least one fan may include a first fan and a second fan. The first fan and the second fan may be powered separately from one another in some instances. Additionally, or alternatively, only one of the first fan and the second fan may be operable at a time. In some instances, the ducting may be dead ended along the shared vent, and the at least one fan pulls gas through the shared vent in a direction away from fluidic coupling of the plurality of electrochemical cells toward the outlet region. In certain instances, the ducting may define an inlet region, the respective headspace of each one of the plurality of electrochemical cells is in fluid communication with the shared vent along the ducting between the inlet region and the outlet region, and the at least one fan is operable to move air into the shared vent via the inlet region. In certain instances, the system may further include a filter disposed along the inlet region of the ducting. The at least one fan may be oriented relative to the shared vent such that, for example, the at least one fan is operable to form positive pressure in the shared vent relative to ambient pressure at the inlet region of the ducting. In some implementations, the system may further include a controller and a first hydrogen sensor, wherein the controller is in electrical communication with the at least one fan and the first hydrogen sensor, the at first hydrogen sensor is arranged to sense hydrogen in the shared vent, and the controller is configured to receive a first signal from the first hydrogen sensor and to control speed of the at least one fan based on a first signal received from the first hydrogen sensor. The first hydrogen sensor may be at least partially disposed in the shared vent between the outlet region of the ducting and the fluidic coupling of the respective headspace of each one of the plurality of electrochemical cells to the shared vent of the ducting. In some instances, the system may further include a second hydrogen sensor in electrical communication with the controller, wherein the controller is further configured to receive a second signal from the second hydrogen sensor and to control speed of the at least one fan based on the first signal and the second signal. In certain cases, the system may further include an enclosure defining an intake opening, an exhaust opening, and a chamber, wherein the intake opening and the exhaust opening are in fluid communication with one another via an environment of the chamber, the plurality of electrochemical cells and the manifold are at least partially disposed in the environment of the chamber with the respective headspace of each one of the electrochemical cells and the shared vent of the ducting fluidically isolated from the environment of the enclosure, and the outlet region of the ducting is in fluid communication with an ambient environment outside of the enclosure. As an example, the system may further include a cooling fan in fluid communication with the environment of the chamber and activatable to pull air into the environment of the chamber via the intake opening and exhaust air from the environment of the chamber via the exhaust opening. An air change of the environment of the chamber may be less than about 30 seconds with the cooling fan activated at maximum rated speed. In some instances, the system may further include a filter material supported along the intake opening of the enclosure. Further, or instead, the system may include evaporative media supported along the intake opening of the enclosure, wherein evaporation of the evaporative media cools air pulled into the environment of the chamber through activation of the cooling fan. In some instances, the system may further include a leak sensor arranged to sense hydrogen in the environment of the chamber, wherein the controller is in electrical communication with the leak sensor and the controller is further configured to receive a third signal from the leak sensor and to activate the cooling fan based on the third signal.

In certain implementations, the system may further include an event sensor including a housing, a film, and a wire, wherein the housing defines a first opening, a second opening, and a volume therebetween, the first opening is in fluid communication with the shared vent of the ducting, the film is disposed in the volume and fluidically isolates the first opening from the second opening in the volume, the wire is in electrical communication with a power source and the film to form at least a portion of a closed circuit and, at a predetermined pressure difference across the film, the film is burstable to switch the closed circuit to an open circuit. The film may have a burst pressure of about 0.35 atmospheres across the film.

In some implementations, the plurality of electrochemical cells may include iron-air type battery cells, zinc-air type battery cells, lithium-air battery cells, or a combination thereof.

According to another aspect, a method of gas management of metal-air batteries may include receiving, from each of one or more hydrogen sensors, a respective signal indicative of hydrogen concentration in a shared vent defined by ducting and in fluid communication between each respective headspace of a plurality of electrochemical cells and an outlet region defined by the ducting, comparing the respective signal from each of the one or more hydrogen sensors to at least one predetermined threshold and, based on comparison of the respective signal of each of the one or more hydrogen sensors to the at least one predetermined threshold, controlling at least one fan in fluid communication with the shared vent and operable to move gas along the shared vent and out of the ducting via the outlet region.

In certain implementations, the at least one predetermined threshold may corresponds to hydrogen concentration less than the lower flammability limit of hydrogen in air at a predetermined temperature and a predetermined pressure. The at least one predetermined threshold may include, for example, a first predetermined threshold and a second predetermined threshold, the second predetermined threshold is greater than the first predetermined threshold, and controlling the at least one fan includes adjusting an operating speed of the at least one fan if the respective signal from any of the one or more hydrogen sensors is between the first predetermined threshold and the second predetermined threshold. Adjusting the operating speed of the at least one fan may include, for example, ramping up the operating speed of the at least one fan if the respective signal from any of the one or more hydrogen sensors is between the first predetermined threshold and the second predetermined threshold. Controlling the at least one fan may include periodically activating the at least one fan at one or more predetermined intervals. Further, or instead, the first predetermined threshold may be 12.5 percent of the lower flammability limit of hydrogen in air at the predetermined temperature and the predetermined pressure. Further, or instead, the second predetermined threshold may be 25 percent of the lower flammability limit of hydrogen in air at the predetermined temperature and the predetermined pressure.

In some implementations, the respective signal from at least one of the one or more hydrogen sensors may be indicative of hydrogen concentration in the shared vent upstream of the at least one fan relative to a direction of gas flow through the at least one fan toward the outlet region of the ducting. The respective signal from the at least one of the one or more hydrogen sensors may be indicative of hydrogen concentration in the shared vent downstream of fluidic coupling of the headspaces of the electrochemical cells to the shared vent relative to the direction of gas flow through the at least one fan toward the outlet region of the ducting.

In certain implementations, the respective signal from the one or more hydrogen sensors may include determining whether each of the one or more hydrogen sensors is operational, and controlling the at least one fan includes operating the at least one fan at 100 percent of rated operating speed if each of the one or more hydrogen sensors is determined to be non-operational.

In some implementations, controlling the at least one fan may include forming vacuum pressure in the shared vent of the ducting.

### DESCRIPTION OF THE DRAWINGS

FIG. 1 is a block diagram of a power generation system in electrical communication with a plant management system, the power generation system including a power generation source, a LODES, an SDES, a power controller, a plant controller, a transmission facility, and a power grid.

FIG. 2 is a block diagram of a power generation system in communication with a plant management system, the power generation system including a plurality of power plants.

FIG. 3 is a schematic representation of an electrochemical cell including a vessel, an air electrode, a negative electrode, a liquid electrolyte, and a current collector.

FIG. 4 is a perspective view of a stackable architecture of a module of electrochemical cells.

FIG. 5A is a schematic representation of vessels of electrochemical cells, with the vessels defining straight channels.

FIG. 5B is a schematic representation of vessels of electrochemical cells, with the vessels defining curved channels.

FIG. 6 is a schematic representation of adjacent electrochemical cells defining straight airflow channels therebetween as compared to adjacent electrochemical cells having spacers therebetween.

FIG. 7A is a partial, cut-away perspective view of a plurality of modules of electrochemical cells disposed in an enclosure.

FIG. 7B is a schematic representation of one of the electrochemical cells within the enclosure in FIG. 7A.

FIG. 7C is a close-up view along the area of detail 7C of the electrochemical cell shown in FIG. 7B.

FIG. 8A is a perspective a system for gas management of metal-air batteries, with the system including a plurality of electrochemical cells and a manifold, the system shown without an enclosure and hardware of the enclosure, and gas flow from the plurality of electrochemical cells and the manifold indicated by arrows.

FIG. 8B is a schematic representation of gas flow through the system of FIG. 8A, with representation of the system and associated gas flow of FIG. 8A simplified for the sake of clarity and the system shown with an enclosure.

FIG. 8C is a schematic representation of a thermal management system of the system of FIG. 8A, with representation of air flow for thermal management of the system of FIG. 8A simplified for the sake of clarity, the system shown with an enclosure, and the gas management system not shown for the sake of clarity.

FIG. 8D is a schematic representation of an event sensor of the system of FIG. 8A, the event sensor including a film having a burst pressure indicative of a pressure event associated with an explosion.

FIG. 9 is a flowchart of an exemplary method of gas management of metal-air batteries.

FIG. 10 is a schematic representation of gas flow for a gas management of metal-air batteries, shown with at least one fan pushing air through a manifold.

FIG. 11 is a schematic representation of gas flow for a gas management of metal-air batteries, shown with a manifold including ducting that is dead-ended.

Like reference symbols in the various drawings indicate like elements.

### DETAILED DESCRIPTION

Embodiments will be described in detail with reference to the accompanying drawings, in which exemplary embodiments are shown. The foregoing may, however, be embodied in many different forms and should not be construed as limited to the exemplary embodiments set forth herein.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and, with existing equipment or activities which may be modified, in-part, based on the teachings of this specification. Further, the various embodiments and examples set forth in this specification may be used with each other, in whole or in part, and in different and various combinations. Thus, the configurations provided in the various embodiments of this specification may be used with each other. For example, the components of an embodiment having A, A′ and B and the components of an embodiment having A″, C and D can be used with each other in various combinations, e.g., A, C, D, and A. A″ C and D, etc., in accordance with the teaching of this Specification.

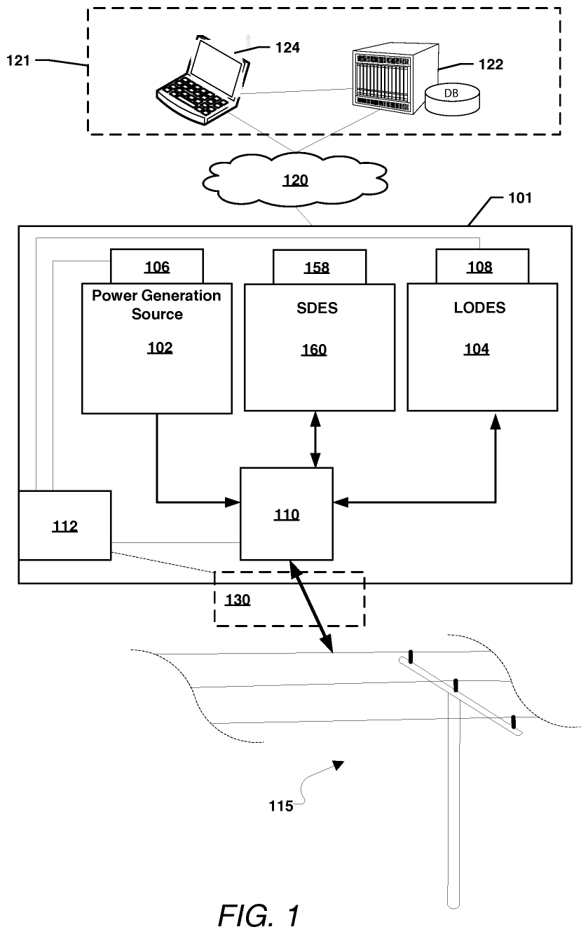

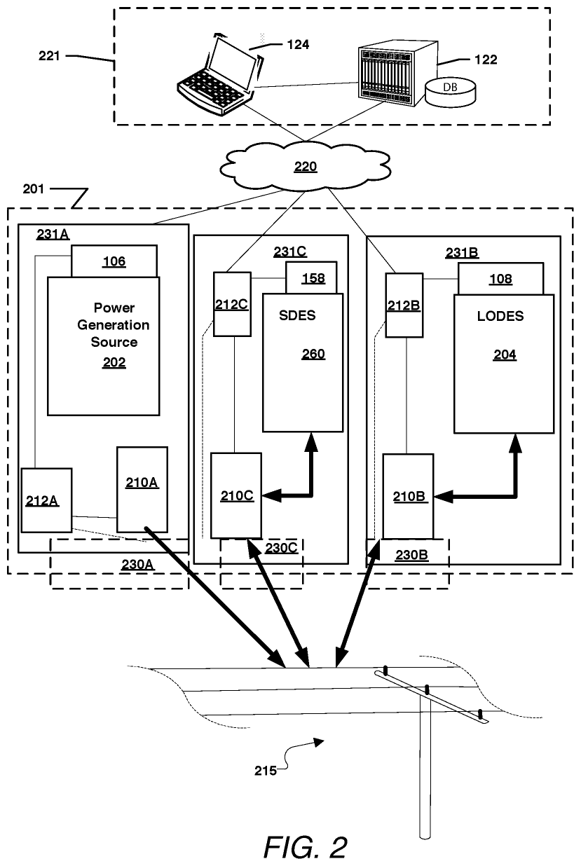

For the sake of clear and efficient description, elements with numbers having the same last two digits in the disclosure that follows shall be understood to be analogous to or interchangeable with one another, unless otherwise specified or made clear from the context, and, therefore, are not described separately from one another, except to note differences and/or to emphasize certain features. For example, in the description that follows, the power generation system 101 (FIG. 1) shall be understood to be analogous to and/or interchangeable with the power generation system 201 (FIG. 2), unless a contrary intent is expressed or made clear from the context.

The present disclosure is directed to systems, methods, and devices for electrochemical energy storage systems, such as metal-air battery systems. Various embodiments may be applicable to gas management in electrochemical energy storage systems, such as metal-air battery systems. Various embodiments may be applicable to explosive and/or flammable gas management in electrochemical energy storage systems, such as metal-air battery systems.

Various embodiments may provide devices and/or methods for use in long-duration, and ultra-long-duration, low-cost, energy storage. Herein, “long duration” and “ultra-long duration” and similar such terms, unless expressly stated otherwise, shall be understood to include periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. and would include long duration energy storage (LODES) systems. Further, the terms “long duration” and “ultra-long duration”, “energy storage cells” including “electrochemical cells”, and similar such terms, unless expressly stated otherwise, shall be understood to include electrochemical cells that may store energy over time spans of days, weeks, or seasons. As used herein, unless a contrary intention is explicitly stated or made clear from the context, the term “duration” shall be understood to refer to a ratio of energy to power of an energy storage system. For example, a system with a rated energy of 24 MWh and a rated power of 8 MW has a duration of 3 hours, and a system with a rated energy of 24 MWh and a rated power of 1 MW has a duration of 24 hours. Physically, the duration may be interpreted as the run-time of the energy storage system at maximum power.

In general, a long duration energy storage cell may be a long duration electrochemical cell. Such a long duration electrochemical cell may store electricity generated from an electrical generation system, when: (i) the power source or fuel for the electrical generation system is available, abundant, inexpensive, or otherwise advantageous; (ii) the power requirements or electrical needs of the electrical grid, customer or other user, are less than the amount of electricity generated by the electrical generation system, the price paid for providing such power to the grid, customer or other user, is below an economically efficient point for the generation of such power (e.g., cost of generation exceeds market price for the electricity), and combinations and variations of these; and (iii) combinations and variations of (i) and (ii) as well as other reasons. The electricity stored in the long duration electrochemical cell can then be distributed to the grid, customer or other user, at times when it is economical or otherwise needed. For example, the electrochemical cells may be configured to store energy generated by solar cells during the summer months, when sunshine is plentiful and solar power generation exceeds power grid requirements. Continuing with this example, the electrochemical cells may discharge the stored energy during the winter months, when sunshine may be insufficient for energy generated by the solar cells to satisfy power grid requirements.

Various embodiments may provide devices and/or methods for use in bulk energy storage systems, such as long duration energy storage (LODES) systems, short duration energy storage (SDES) systems, etc. As an example, various embodiments may provide configurations and controls for batteries of bulk energy storage systems, such as batteries for LODES systems.

While various examples are discussed with reference to Li-ion and/or Fe-air, the discussion of Li-ion and/or Fe-air is used merely as an example. Unless otherwise specified or made clear from the context, other combinations and permutations of storage technologies may be substituted for the example solar+Li-ion+Fe-air discussed herein. For example, various metal-air storage technologies may be used as batteries in the various embodiments, such as zinc-air, lithium-air, sodium-air, etc.

U.S. Pat. App. Pub. 2021/0028457, entitled “LOW COST METAL ELECTRODES,” which published on Jan. 28, 2021, the entire contents of which are hereby incorporated herein by reference, describes various aspects of electrochemical cells, such as rechargeable batteries using metal electrodes (e.g., iron negative electrodes), and design, manufacture, and processing features of electrochemical cells, such as rechargeable batteries using iron metal electrodes (e.g., iron negative electrodes), with which various embodiments described herein may be used and into which various embodiments described herein may be incorporated. Additionally, U.S. Pat. App. Pub. 2021/0028457 provides examples of metal materials (e.g., iron materials) with which various embodiments described herein may be used. Further, U.S. Pat. App. Pub. 2021/0028457 describes bulk energy storage systems, such as LODES systems, with which various embodiments described herein may be used and into which various embodiments as described herein may be incorporated.

As used herein, a “module” may include a string of unit electrochemical cells (e.g., a string of batteries). Multiple modules (or multiple units or cells) may be connected together to form battery strings.

Referring now to FIG. 1, a power generation system 101 may include a power generation source 102, a LODES 104, and an SDES 160. As examples, the power generation sources 102 may include renewable power generation sources, non-renewable power generation sources, combinations of renewable and non-renewable power generation sources, etc. Examples of power generation sources 102 may include any one or more of wind-powered generators, solar-powered generators, geothermal-powered generators, nuclear-powered generators, etc. As an example, the LODES 104 may include one or more electrochemical cells (e.g., one or more batteries). The batteries may be any type of battery, such as rechargeable secondary batteries, refuellable primary batteries, combinations of primary and secondary batteries, etc. Battery chemistries may be any chemistry, such as Al, AlCl3, Fe, FeOx(OH)y, NaxSy, SiOx(OH)y, AlOx(OH)y, metal-air, and/or any type of battery chemistry suitable for a particular implementation. The SDES 160 may include one or more electrochemical cells (e.g., one or more batteries). The batteries may be any type of battery, such as rechargeable secondary batteries, refuellable primary batteries, combinations of primary and secondary batteries, etc. Battery chemistries may be any chemistry, such as Li-ion, Na-ion, NiMH, Mg-ion, and/or any type of battery chemistry suitable for a particular implementation.

In various embodiments, the power generation system 101 may include a first control system 106 for controlling operation of the power generation source 102. The first control system 106 may include motors, pumps, fans, switches, relays, or any other type of devices associated with controlling one or more aspects of electricity generation by the power generation source 102. The second control system 108 may include motors, pumps, fans, switches, relays, or any other type devices that may serve to control the discharge and/or storage of electricity by the LODES. In various embodiments, the power generation system 101 may further, or instead, include a third control system 158 for controlling the SDES 160. The third control system 158 may include motors, pumps, fans, switches, relays, or any other type devices that may serve to control the discharge and/or storage of electricity by the SDES 160. The first control system 106, the second control system 108, and the third control system 158 may each be connected to a plant controller 112. The plant controller 112 may monitor the overall operation of the power generation system 101 and generate and, for example, generate and send control signals to one or more of the first control system 106, the second control system 108, or the third control system 158 as necessary or useful to control the respective operations of the power generation source 102, the LODES 104, and/or the SDES 160.

The power generation source 102, the LODES 104, and the SDES 160 may each be connected to a power controller 110. The power controller 110 may be connected to a power grid 115 or other electrical transmission infrastructure. The power controller 110 may include, for example, switches, inverters (e.g., AC to DC inverters, DC to AC inverters, etc.), relays, power electronics, and any other type of equipment that may facilitate controlling the flow of electricity from to/from one or more of the power generation source 102, the LODES 104, the SDES 160, and/or the power grid 115. Additionally, or alternatively, the power generation system 101 may include a transmission facility 130 connecting the power generation system 101 in electrical communication with the power grid 115. As an example, the transmission facility 130 may selectively establish electrical communication between the power controller 110 and the power grid 115. As an example, the transmission facility 130 may include transmission lines, distribution lines, power cables, switches, relays, transformers, and/or any other type devices that supports the flow of electricity in either direction between the power generation system 101 and the power grid 115.

The power controller 110 and/or the transmission facility 130 may be in electrical communication with the plant controller 112. The plant controller 112 may monitor and control the operations of the power controller 110 and/or the transmission facility 130, such as via various control signals. As examples, the plant controller 112 may control the power controller 110 and/or the transmission facility 130 to provide electricity from the power generation source 102 to the power grid 115, to provide electricity from the LODES 104 to the power grid 115, to provide electricity from both the power generation source 102 and the LODES 104 to the power grid 115, to provide electricity from the power generation source 102 to the LODES 104, to provide electricity from the power grid 115 to the LODES 104, to provide electricity from the SDES 160 to the power grid 115, to provide electricity from both the power generation source 102 and the SDES 160 to the power grid 115, to provide electricity from the power generation source 102 to the SDES 160, to provide electricity from the power grid 115 to the SDES 160, to provide electricity from the SDES 160 and the LODES 104 to the power grid 115, to provide electricity from the power generation source 102, the SDES 160, and the LODES 104 to the power grid 115. In various embodiments, the power generation source 102 may selectively charge the LODES 104 and/or SDES 160 and the LODES 104 and/or SDES 160 may selectively discharge to the power grid 115. In this manner, energy (e.g., renewable energy, non-renewable energy, etc.) generated by the power generation source 102 may be output to the power grid 115 from the LODES 104 and/or the SDES 160 at some time after the energy has been generated by the power generation source 102.

In various embodiments, plant controller 112 may be in communication with a network 120 (e.g., 3G network, 4G network, 5G network, core network, Internet, combinations of the same, etc.). Using the connections to the network 120, the plant controller 112 may exchange data with the network 120 and with devices connected to the network 120, such as a plant management system 121 or any other device connected to the network 120. The plant management system 121 may include one or more computing devices, such as a computing device 124 and a server 122. The computing device 124 and the server 122 may be connected to one another directly and/or via connections to the network 120. The various connections to the network 120 by the plant controller 112 and the plant management system 121 (e.g., by the computing device 124 and/or the server of the plant management system 121) may be wired and/or wireless connections.

In various embodiments, the computing device 124 of the plant management system 121 may provide a user interface through which a user of the plant management system 121 may define inputs to the plant management system 121 and/or to the power generation system 101, receive indications associated with the plant management system 121 and/or with the power generation system 101, or otherwise control the operation of the plant management system 121 and/or the power generation system 101.

While shown as two separate devices, 124 and 122, it shall be appreciated that this is for the sake of clear and efficient depiction and that the functionality of the computing device 124 and the server 122 described herein may be combined into a single computing device or may split among more than two devices. Additionally, or alternatively, while shown as a dedicated part of the plant management system 121, the functionality of the computing device 124 and the server 122 may be in whole, or in part, carried out by a remote computing device, such as a cloud-based computing system. While shown as being in communication with a single instance of the power generation system 101, it shall be understood that the plant management system 121 may be in communication with multiple instances of the power generation system 101, unless otherwise specified or made clear from the context.

While shown as being co-located with one another in FIG. 1, any one or more of the power generation source 102, the LODES 104, and the SDES 160 may be separated from one another in various embodiments. For example, the LODES 104 may be downstream of a transmission constraint (e.g., downstream of a portion of the power grid 115, etc.) from the power generation source 102 and the SDES 160. In this manner, the over build of underutilized transmission infrastructure may be reduced, or avoided entirely, by situating the LODES 104 downstream of a transmission constraint, charging the LODES 104 at times of available capacity and discharging the LODES 104 at times of transmission shortage. The LODES 104 may also, or instead, arbitrage electricity according to prevailing market prices to reduce the final cost of electricity to consumers.

Referring now to FIG. 2, a power generation system 201 may include a power generation source 202 and one or more bulk energy storage systems, such as a LODES 204 and/or an SDES 260, physically separated from one another. For example, the power generation source 202, the LODES 204, and the SDES 260 may be separated in different power plants 231A, 231B 231C, respectively. While the power plants 231A, 231B, 231C may be separated, the power generation system 201 and a plant management system 221 may operate as described above with reference to operation of the power generation system 101 and the plant management system 121 (FIG. 1). The power plants 231A, 231B, and 231C may be co-located or may be geographically separated from one another. The power plants 231A, 231B, and 231C may connect to a power grid 215 at different places. For example, the power plant 231A may be connected to the power grid 215 upstream of where the power plant 231B is connected to the power grid 215.

In some implementations, the power plant 231A associated with the power generation source 202 may include dedicated equipment for the control of the power plant 231A and/or for transmission of electricity to/from the power plant 231A. For example, the power plant 231A may include a plant controller 112A and a power controller 210A and/or a transmission facility 230A. The power controller 210A and/or the transmission facility 230A may be connected in electrical communication with the plant controller 212A. The plant controller 212A may, for example, monitor and control the operations of the power controller 210A and/or of the transmission facility 230A, such as via various control signals. As examples, the plant controller 212A may control the power controller 210A and/or transmission facilities 230A to provide electricity from the power generation source 202 to the power grid 215, etc.

Additionally, or alternatively, the power plant 231B associated with the LODES 204 may include dedicated equipment for the control of the power plant 231B and/or for transmission of electricity to/from the power plant 231B. For example, the power plant 231B associated with the LODES 204 may include a plant controller 212B, a power controller 210B, and/or a transmission facility 230B. The power controller 210B and/or the transmission facility 230B may be connected to the plant controller 212B. The plant controller 212B may monitor and control the operations of the power controller 210B and/or the transmission facilities 230B, such as via various control signals. As example, the plant controller 212B may control the power controller 210B and/or the transmission facility 230B to provide electricity from the LODES 204 to the power grid 215 and/or to provide electricity from the power grid 215 to the LODES 204, etc.

Still further, or instead, the power plant 231C associated with the SDES 260 may include dedicated equipment for the control of the power plant 231C and/or for transmission of electricity to/from the power plant 231C. For example, the power plant 231C associated with the SDES 260 may include a plant controller 212C and a power controller 210C and/or a transmission facility 230C. The power controller 210C and/or the transmission facility 230C may be connected to the plant controller 212C. The plant controller 212C may monitor and control the operations of the power controller 210C and/or of the transmission facility 230C, such as via various control signals. As examples, the plant controller 212C may control the power controller 210C and/or the transmission facility 230C to provide electricity from the SDES 260 to the power grid 215 and/or to provide electricity from the power grid 215 to the SDES 260, etc.

In various embodiments, the respective plant controllers 212A, 212B, 212C may be in communication with a network 220. Using the connections to the network 220, the plant controllers 212A, 212B, 212C may exchange data with the network 220 as well as with one or more devices connected to the network 220, such as the plant management system 221, each other, or any other device connected to the network 220. In various embodiments, the operation of the plant controllers 212A, 212B, 212C may be monitored by the plant management system 221 and the operation of the plant controllers 212A, 212B, 212C—and, thus, operation of the power generation system 201 may be controlled by the plant management system 221.

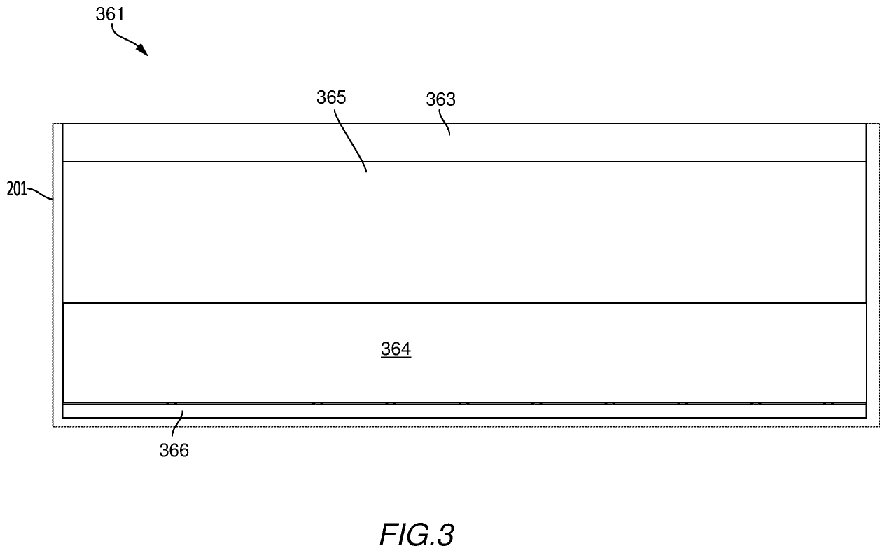

FIG. 3 is a schematic view of an electrochemical cell 361 that may be used as a battery in the one or more LODES described herein (e.g., LODES 104 in FIG. 1 and/or LODES 204 in FIG. 2). The electrochemical cell 361 may be one type of battery that may be used in a LODES 104 in various embodiments. The electrochemical cell 361 may include a vessel 362, and air electrode 363, a negative electrode 364, a liquid electrolyte 365, and a current collector 366. The air electrode 363, the negative electrode 364, the liquid electrolyte 365, and the current collector 366 may each be disposed in the vessel 362. The negative electrode 364 may be a metal electrode (e.g., an iron electrode, a lithium electrode, a zinc electrode, or other type of suitable metal). The liquid electrolyte 365 may separate the air electrode 363 from the negative electrode 364. As examples, the electrochemical cell 361 may be a metal-air type of battery, such as an iron-air battery, lithium-air battery, zinc-air battery, etc. While various examples are described herein with reference to metal-air batteries, other type batteries may be additionally, or alternatively, used in the various examples provided herein unless otherwise specified or made clear from the context. The electrochemical cell 361 may represent a single cell or unit, and multiple instances of the electrochemical cell 361—namely, multiple units or electrochemical cells—may be connected together to form a module. Multiple modules may be connected to one another to form a battery string.

In various implementations, the negative electrode 364 may be solid and the liquid electrolyte 365 may be excluded from the negative electrode 364. In certain implementations the negative electrode 364 may be porous and the liquid electrolyte 365 may be interspersed geometrically with the negative electrode 364, creating a greater interfacial surface area for reaction. In some implementations, the air electrode 363 may be positioned at the interface of the liquid electrolyte and a gaseous headspace (not shown in FIG. 3). As described below, the gaseous headspace may be sealed in a housing.

The negative electrode 364 may be formed from a metal or metal alloy, such as lithium (Li), sodium (Na), potassium (K), magnesium (Mg), calcium (Ca), silicon (Si), aluminum (Al), zinc (Zn), or iron (Fe); or alloys substantially comprised of one or more of the forgoing metallic elements, such as an aluminum alloy or iron alloy (e.g., FeAl, FeZn, FeMg, etc.) that can undergo an oxidation reaction for discharge. As such, the negative electrode 364 may be referred herein as the metal electrode.

In certain implementations, the electrochemical cell 361 may be rechargeable and the negative electrode 364 may undergo a reduction reaction when the electrochemical cell 361 is charged. The negative electrode 364 may be a solid, including a dense or porous solid, or a mesh or foam, or a particle or collection of particles, or may be a slurry, ink, suspension, or paste deposited within a housing. In various implementations the composition of the negative electrode 364 may be selected such that the negative electrode 364 and the liquid electrolyte 365 may not mix together. For example, the negative electrode 364 may be a metal electrode that may be a bulk solid. As another example, the negative electrode 364 may be a collection of particles, such as small or bulky particles, within a suspension that are not buoyant enough to escape the suspension into the liquid electrolyte 365. As another example, the negative electrode 364 may be formed from particles that are not buoyant in the liquid electrolyte 365.

The air electrode 363 may support the reaction with oxygen on the positive electrode. The air electrode 363 may be a so-called gas diffusion electrode (GDE) in which the cathode is a solid and sits at the interface of a gas headspace and the liquid electrolyte 365. During the discharge process, the air electrode 363 supports the reduction of oxygen from the gaseous headspace, the so-called Oxygen Reduction Reaction (ORR). In certain instances, the battery 200 may be rechargeable and the reverse reaction occurs, in which the air electrode 203 supports the evolution of oxygen from the electrochemical cell 361, the so-called Oxygen Evolution Reaction (OER). The OER and ORR reactions are commonly known to those skilled in the art.

In various implementations, the liquid electrolyte 365 may be an aqueous solution, a non-aqueous solution, or a combination thereof. For example, the liquid electrolyte 365 may be an aqueous solution which may be acidic (low-pH), neutral (intermediate pH), or basic (high pH; also called alkaline or caustic). In certain implementations, the liquid electrolyte 365 may include an electropositive element, such as Li, K, Na, or combinations thereof. In some implementations, the liquid electrolyte 365 may be basic, namely with a pH greater than 7 (e.g., with a pH greater than 10, a pH greater than 12, etc.). For example, the liquid electrolyte 365 may include a 6M (mol/liter) concentration of potassium hydroxide (KOH). In certain implementations, the liquid electrolyte 365 may include a combination of ingredients such as 5.5M potassium hydroxide (KOH) and 0.5M lithium hydroxide (LiOH). In certain instances, the liquid electrolyte 365 may comprise a 6M (mol/liter) concentration of sodium hydroxide (NaOH). In some instances, the liquid electrolyte 365 may include a 5M (mol/liter) concentration of sodium hydroxide (NaOH) and 1M potassium hydroxide (KOH).

In certain implementations, the electrochemical cell 361 may discharge by reducing oxygen (O2) typically sourced from air. This requires a triple-phase contact between gaseous oxygen, an electrically active conductor which supplies the electrons for the reduction reaction, and the liquid electrolyte 365 which contains the product of the reduction step. For example, in certain embodiments involving an aqueous alkaline electrolyte, oxygen from air is reduced to hydroxide ions through the half-reaction O2+H2O+4e−→4OH—. Thus, oxygen delivery to metal-air cells requires gas handling and maintenance of triple-phase points. In “normal air-breathing” implementations, the air electrode 363 may be mechanically positioned at the gas-liquid interface to promote and maintain triple-phase boundaries. The air electrode 363 may be positioned vertically or horizontally, or at any intermediate angle with respect to gravity, and maintain a “normal air-breathing” operation. In these “normal air-breathing” implementations, the gas phase may be at atmospheric pressure—that is, the gas phase may be unpressurized beyond the action of gravity.

The electrochemical cell 361 in FIG. 3 is merely an example of one arrangement and is not intended to be limiting. Thus, unless otherwise specified or made clear from the context, it shall be understood that other arrangements may additionally, or alternatively, be used such as electrochemical cells with different types of vessels and/or without the vessel 362, electrochemical cells with different types of air electrodes and/or without the air electrode 363, electrochemical cells with different types of current collectors and/or without the current collector 366, electrochemical cells with different type negative electrodes and/or without the negative electrode 364, and/or electrochemical cells with different types of electrolytes and/or electrochemical cells without the liquid electrolyte 365 may be substituted for the electrochemical cell 361 shown in FIG. 3 and other configurations are in accordance with the various embodiments.

In certain implementations, the vessel 362 may be at least partially formed of a polymer such as polyethylene, acrylonitrile butadiene styrene (ABS), high-density polyethylene (HDPE), ultra-high molecular weight polyethylene (UHMW), polypropylene, and/or other polymers. Additionally, or alternatively, the vessel 362 and/or a housing for the electrochemical cell 361 may be at least partially formed of a metal such as nickel, steel, anodized aluminum, nickel coated steel, nickel coated aluminum, or other metal.

In certain implementations, the electrochemical cell 361 may include three electrodes—the negative electrode 364 and the air electrode 363, with the air electrode 363 having two parts, such as a first cathode, and a second cathode. Further, or instead, the electrodes described herein may have finite useful lifetimes, and may be mechanically replaceable. For example, the negative electrode 364 may be replaced seasonally. In instances in which the air electrode 363 has two parts, a first cathode may include a first portion having a hydrophilic surface and a second portion having a hydrophobic surface. For example, the hydrophobic surface may have a polytetrafluorethylene (PTFE) (e.g., Teflon™, available from The Chemours Company of Wilmington, DE) hydrophobic surface.

Additionally, or alternatively, in instances in which the air electrode 363 has two parts, the second portion of the air electrode 363 may include a microporous layer (MPL) of polytetrafluorethylene (PTFE) and high surface area carbon while the first portion may be carbon fiber partially coated with PTFE. As another example, the second portion of the air electrode 363 may include an MPL of PTFE and carbon black and the first portion of the air electrode 363 may include PTFE of approximately 33% by weight. As a further example, the second portion of the air electrode 363 may include an MPL of 23% by weight PTFE and 77% by weight carbon black and the first portion of the air electrode 363 may be a low loading MPL. The negative electrode 364 may be an iron (Fe) electrode or an iron-alloy (Fe-alloy) electrode (e.g., FeAl, FeZn, FeMg, etc.). The second cathode of the air electrode 363 may have a hydrophilic surface. The second cathode of the air electrode 363 may have a metal substrate, such as carbon (C), titanium (Ti), steel, etc., coated with nickel (Ni). The liquid electrolyte 365 may be disposed between the three electrodes. The liquid electrolyte 365 may be infiltrated into one or more of the three electrodes.

Battery systems may be comprised of a number of electrochemical cells connected in series and/or parallel in a shared electrolyte bath, and contained within in a housing.

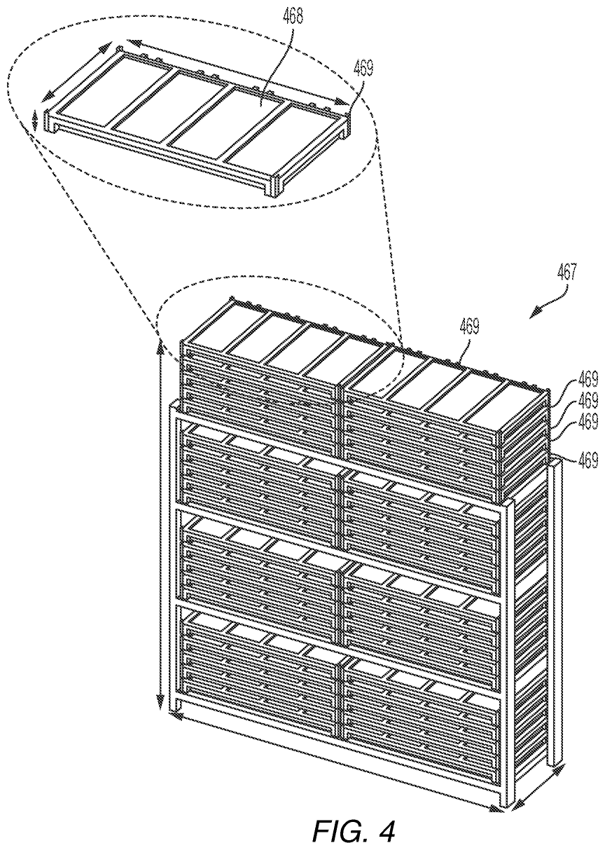

Referring now to FIG. 4, a module 467 may include a plurality of electrochemical cells 468 in a stackable architecture. In certain implementations, the plurality of electrochemical cells 468 may be disposed in a housing 469, with the plurality of electrochemical cells 468 ionically isolated from one another by a dividing wall which is electrically insulating. Each one of the plurality of electrochemical cells 468 may have an air electrode (e.g., any one or more of the various different air electrodes described herein) on top with multiple instances of the plurality of electrochemical cells 402 in the housing 469. The instances of the plurality of electrochemical cells 402 in the housing 469 may be connected ionically (permeating electrolyte) or may be hydraulically/ionically separated. Multiple instances of the housing 469 may be stacked on one another to form the module 467. For example, in FIG. 4, the module 467 is shown as including 40 instances of the housing 469. While multiple instances of the housing 469 are shown as being stacked horizontally, it shall be appreciated that multiple instances of the housing 469 may additionally, or alternatively, be arranged vertically.

Air electrodes (cathodes) may have a finite tolerance to holding liquid pressure such as, for example, in a vertical electrode orientation in which the air electrode acts as a wall retaining the hydrostatic pressure of the electrolyte.

In some implementations, the liquid electrolyte may be retained with a separator that may, for example, be nanoporous. The liquid electrolyte may leak past the separator and into a narrow gap between the separator and the air electrode. Continuing with this example, there may be an outlet at the bottom of the air electrode for the liquid electrolyte to flow out of the gap and into the next electrochemical cell. This flow is slow and results in less pressure on the air electrode as compared to hydrostatic force of the liquid electrolyte.

In some implementations, the separator may be disposed directly on the liquid electrolyte side of the air electrode, as may be useful for reducing the pressure-differential across the air electrode through surface tension or other pressure-reducing mechanisms. The thickness and/or porosity of the separator may vary with depth. For example, the separator may get thicker at the bottom of the electrochemical cell, where the hydrostatic pressure on the air electrode “wall” is the greatest.

In some implementations, the air electrode may include staged pressure relief points through which the liquid electrolyte may low and leak, resetting the hydrostatic pressure of the liquid electrolyte to atmospheric pressure. In certain implementations, the air electrode may be self-healing (e.g., a cork-like material) such that small pin-holes or leak points reseal themselves when wetted by the liquid electrolyte. Additionally, or alternatively, an electrolyte additive (e.g., platelets) may be used to seal small pin-holes or leak points.

In certain implementations, a sealed vertical submerged (SVS) air electrode may be combined with a flow field with air and/or oxygen gas flow from a manifold. The flow field may include a plastic (e.g., polypropylene, HDPE) or a metal (e.g., steel, nickel). The flow field may, in some instances, serve as a current collector and/or may include an embedded current collector. The flow field may be compressed against the air electrode to facilitate direct delivery of gas from air flow channels to the air electrode. The flow field may both collect current and direct air flow. The flow field may include both a metal and a plastic insulating material.

In some instances, the flow field may be against a hydrophobic coating side of a sheeted air electrode, and may define a series of channels that are 0.1 mm to 5 cm wide and 0.1 mm to 1 cm deep. In some implementations, the flow field may include a gas diffusion layer (GDL). The flow channels may be parallel to one another, interdigitated with one another, serpentine, or in a spiral geometric pattern. In certain implementations, the flow channels in the flow field may have an elliptical cross section useful for forming small landing contacts between the air electrode and the flow field which, in turn, may facilitate high flow velocities at low pressure drop. The flow field may facilitate controlling the airflow across and/or into the air electrode, with various design patterns of the flow field targeting different operating powers and various flooding mitigation. Further, or instead, the flow field may facilitate the use of a broader array of air electrode designs, especially regarding oxygen transport through the thickness of the air electrode and into a catalyst layer. In certain implementations, an electrically conductive flow field may facilitate using an air electrode with no embedded current collector. For use in systems with alkaline electrolytes, a conductive flow field may include carbon, graphite, nickel, or nickel-plated steel.

Serpentine flow fields may facilitate achieving a long residence time of a reactant gas in the electrochemical system, with such long residence times aiding in increasing the air utilization. Serpentine flow fields, however, may exhibit large pressure drops due to the presence of a thin, winding gas delivery channel. Therefore, in certain implementations, the serpentine channel may be broken into multiple segments to facilitate achieving targets of air utilization and pressure drop. The number of connected serpentine segments may be adjusted to achieve target air utilization and pressure drop. More connected serpentine segments may yield higher air utilization and higher pressure drop, while fewer connected serpentine segments may yield lower air utilization and lower pressure drop. As an example, the serpentine flow channel may be broken into segments having multiple inlet and outlet gas delivery points located along larger inlet and outlet manifolds.

In certain implementations, the flow channels in the flow field may be tapered, which may regulate air pressure inside the air flow channel. In particular, tapered flow channels may constrict air flow as air passes from the inlet (bottom of the cell) to the outlet (top of the cell) of the flow field by imposing higher pressure drop. In certain embodiments, the volumetric flow rate of air may be held constant, and the resulting increased gas pressure inside the flow channel may counterbalance the hydraulic pressure at the bottom of the cell.

In certain implementations, the geometry of the flow field, such as the width of channels, organization of the channels as serpentine, interdigitated, etc., may be used to modify pressure along the air path within a single subassembly, causing a desired gradient of pressures in a desired pattern to facilitate matching the surrounding hydrostatic pressure across the electrode depth. For example, the highest pressure air can enter the bottom of the chamber, where surrounding electrolyte pressure is highest. As gas travels upward through the flow field, resistance in the flow field reduces the air pressure. The field resistances may be designed to reduce pressure in the gas stream at an appropriate rate. For example, field resistances may be designed to match or substantially match the smaller electrolyte pressures associated with moving upward in the vessel, maintaining constant or substantially constant across-electrode pressure gradients. Pressure-reducing geometric features, such as orifices, may also or instead be used to modify pressure along the air flow path within an air electrode subassembly.

In various implementations, a plurality of electrochemical cells may be connected to one another to form a module, such as a module that may be lifted by a fork-lift. Additionally, or alternatively, the module of electrochemical cells may need airflow going in and through, as described above. In addition, or in the alternative, the airflow in the module may be arranged for cooling of each electrochemical cell.

The vessel that holds the liquid electrolyte in each electrochemical cell within the module may define airflow channels that may additionally, or alternatively serve as cooling channels. In such implementations, when the electrochemical cells are stacked together, air may flow through the cooling channels defined by the vessels of the electrochemical cells. In various implementations, the airflow channels may include a ducting system at least partially defined by protrusions or gaps in the walls of the electrolyte-containing vessel. The vessel may be constructed, for example, of various plastics (e.g., ABS, HDP, polypropylene, etc.).

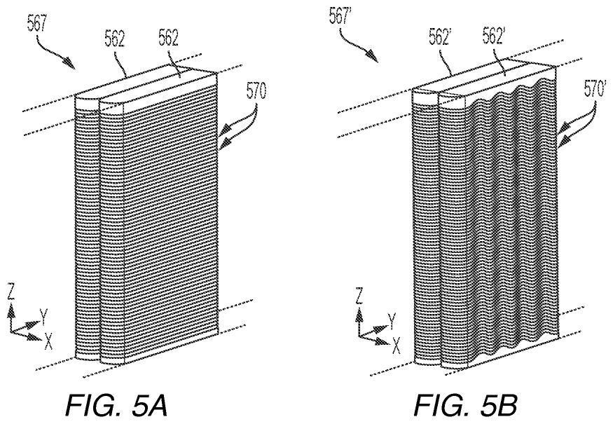

Referring now to FIG. 5A, a module 567 may include a plurality (e.g., two) instances of a vessel 562 in which each instance of the vessel 562 defines a plurality of straight airflow channels 570 for cooling.

Referring now to FIG. 5B, a module 567′ may include a plurality (e.g., two) instances of a vessel 562′ in which each instance of the vessel 562′ defines a plurality of curved air flow channels 570′ for cooling.

The number of airflow channels may depend on the size and/or the configuration of the electrochemical cells of the module (e.g., series or parallel connections).

In various implementations, the airflow may be uniformly distributed across the channels. However, thermal management using natural convection may be challenging when the channels are all uniform. Specifically, the heat difference in temperature across a electrochemical cell may lead to different cooling rates at different heights along the electrochemical cell. Since non-uniformity in cooling may increase degradation of one or more components of the electrochemical cell, the airflow channels may have varying sizes and/or spacing to accommodate for these differences.

For example, spacing between the airflow channels and/or size of the airflow channels may vary based on vertical height along each electrochemical cell of the module. In particular, as discussed above, the hydrostatic pressure of the liquid electrolyte may be highest toward the bottom of the vessel of the electrochemical cell, and may decrease toward the top of the vessel. As such, the required strength of the material (e.g., plastic) may be lowest at the top of the vessel, facilitating forming the vessel with a large cooling area (e.g., larger channel size and/or smaller spacing between channels) without compromising the structural performance of the vessel. By comparison, the required strength of the material of (e.g., plastic) of the vessel may be greatest at the bottom of the vessel. Therefore, at lower heights along the vessel, the walls of the vessel may have fewer airflow channels and/or more spaced out airflow channels to facilitate maintaining sufficient strength of the vessel to accommodate the hydrostatic pressure of the liquid electrolyte in the vessel.

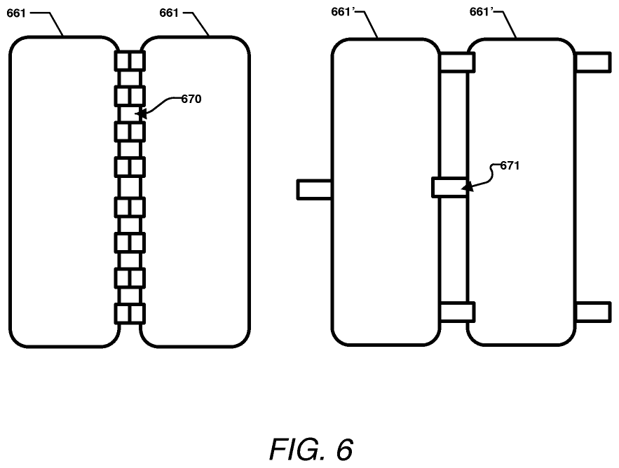

In some implementations, instead of or in addition to channels for airflow, adjacent vessels of electrochemical cells within a battery module may include spacers therebetween to facilitate airflow between the adjacent vessels for cooling. In particular, FIG. 6 is a schematic representation of adjacent electrochemical cells 661 defining straight airflow channels 670 therebetween as compared to adjacent electrochemical cells 661′ having spacers 671 therebetween. In various implementations, the use of spacers may facilitate achieving greater airflow, and reduce the likelihood of interlocking that can occur between channels of adjacent vessels of electrochemical cells within a module. In certain instances, a minimum number of spacers may be utilized to facilitate achieving high airflow while maintaining the required structure. For example, the spacing between spacers may change with height due to variance in the hydrostatic pressure of the liquid electrolyte in the vessel, as discussed above. Further, or instead, the channels and/or spacers used for thermal cooling via airflow may be produced by various known manufacturing techniques, such as 3D printing, extrusion, blow molding, injection molding, etc.

Having described various aspects of power generation systems and modules of electrochemical cells that may be used in such power generation systems, attention is now directed to gas management of metal-air batteries. In particular, electrochemical cells of certain implementations described herein may produce a byproducts of hydrogen (H₂) and oxygen (O₂) gas at different concentrations during charging and self-discharge. The accumulation of this gas (referred to herein as oxyhydrogen) in an enclosed space—such as within an electrochemical cell and/or a module of electrochemical cells—may pose a risk of forming a flame or explosion under certain conditions. The systems, methods, and devices of gas management of metal-air batteries described below are generally directed to mitigating the risk of the oxyhydrogen forming a flame or explosion. For example, as described below, certain systems and methods of gas management of metal-air batteries include diluting oxyhydrogen with external ambient air and/or monitoring hydrogen concentration. Additionally, or alternatively, as also described below, certain systems, and methods of gas management of metal-air batteries include monitoring hydrogen concentration to make efficient use of the amount of power required for gas management.

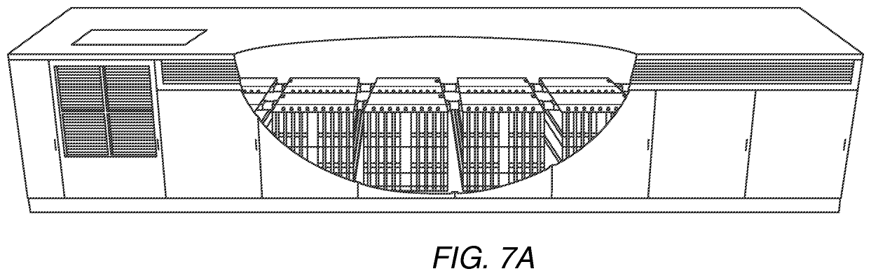

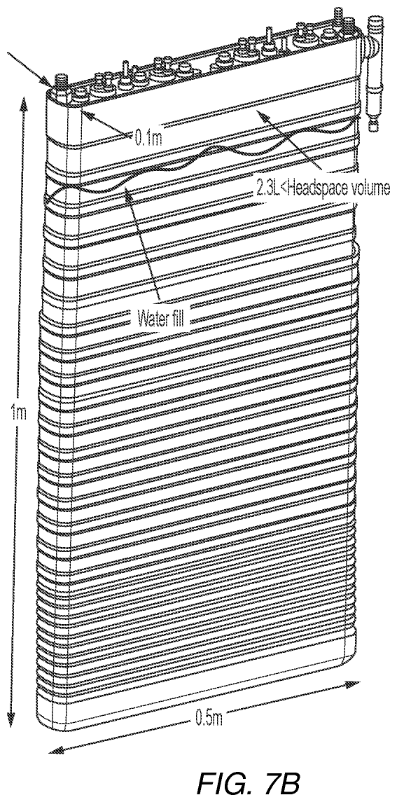

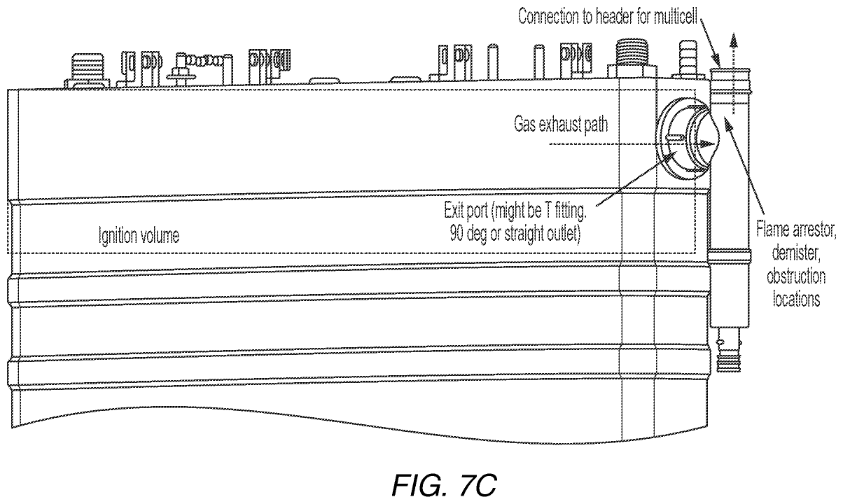

FIG. 7A is a partial, cut-away perspective view of a plurality of modules of electrochemical cells disposed in an enclosure. Inside the enclosure, the modules may be attached to hardware providing the electrochemical cells with fluids required for operation of the electrochemical cells. Further, or instead, hardware within the enclosure may include fans, DC/DC converters, pumps, and/or other electromechanical equipment. Such equipment is generally not meant to be explosion proof since the H₂ formed in the electrochemical cells is physically sealed off from the rest of the enclosure.

FIG. 7B is a schematic representation of an electrochemical cell in which the headspace is sealed except for a port that leads to a T-fitting. In various implementations, the electrochemical cell may be made from HDPE with a flame-resistant plastic lid where the busbars and PCBs for controls connect to one another. While the headspace of the electrochemical cell headspace may have fully insulated busbars, there remains a possibility of an ignition source due to manufacturing, assembly, transport damage, or other reasons that could jeopardize the insulation on the busbars. FIG. 7C is a close-up view of the electrochemical cell of FIG. 7B, and shows an escape path for exhaust gas in case of an ignition source in the headspace of an electrochemical cell.

For example, on the top of the exhaust line, a flame arrestor (e.g., formed of polypropylene) that can be blown off in case of overpressure (to reduce the likelihood of the flame arrestor becoming a pressure resistance in case of a pressure event, such as an explosion) may be installed. The bottom of the T-fitting may connect to a water management system and may have a water line connected to a pump and 250-gallon water tank. Inside the electrochemical cell, there may also be an “open volume” of 3 L filled with air, that can mitigate some of the damage by compressing when the pressure wave moves through the liquid.

Having described certain aspects of gas management within the electrochemical cell itself, attention is now directed to gas management of oxyhydrogen mixtures that are exhausted from the electrochemical cells of the modules.

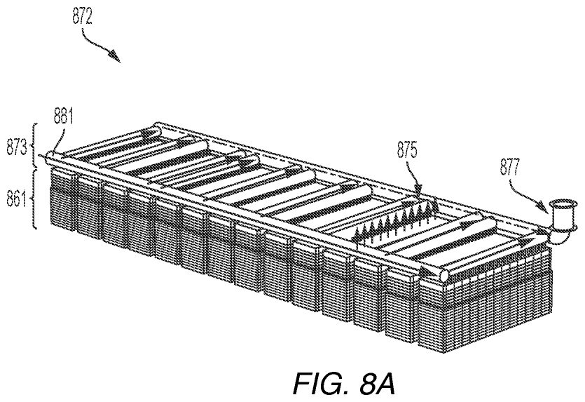

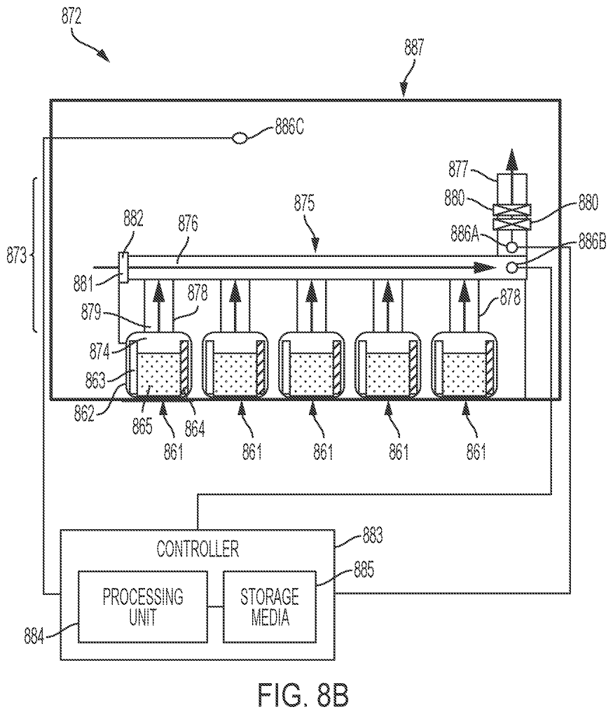

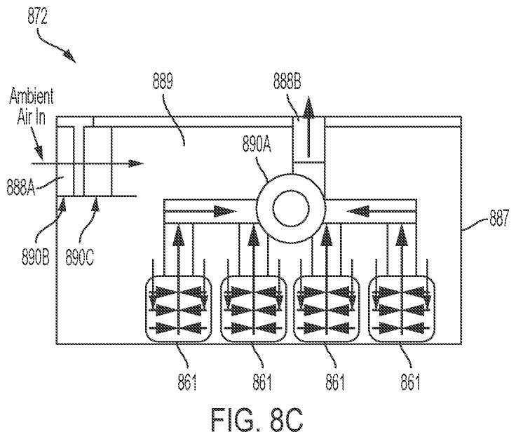

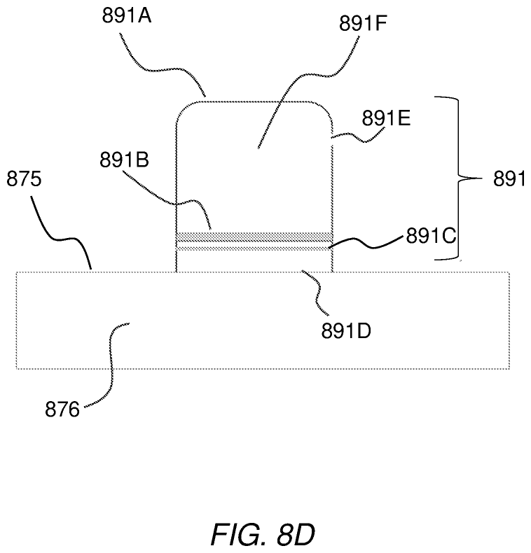

Referring now to FIGS. 8A and 8B, a system 872 for gas management of metal-air batteries may include a plurality of electrochemical cells 861 and a manifold 873. Each one of the plurality of electrochemical cells 861 may include at least one air electrode 863, a metal electrode 864, a vessel 862, and a liquid electrolyte 865 between the at least one air electrode 863 and the metal electrode 864 in the vessel 862. Thus, for example, the plurality of electrochemical cells 861 may include iron-air type battery cells, zinc-air type battery cells, lithium-air battery cells, or a combination thereof. Each one of the electrochemical cells 861 may define a respective headspace 874 above the liquid electrolyte 865 in the vessel 862. The manifold 873 includes ducting 875 defining a shared vent 876 and an outlet region 877. The respective headspace 874 of each one of the plurality of electrochemical cells 861 may be fluidically coupled to the shared vent 876 and in fluid communication with the outlet region 877 of the ducting 875 such that the plurality of electrochemical cells 861 may vent to the shared vent 876, where oxyhydrogen in the shared vent 876 may be diluted by ambient air in the shared vent 876. As compared to sweeping oxyhydrogen from the respective headspace of each of a plurality of electrochemical cells, venting oxyhydrogen from the plurality of electrochemical cells 861 into the shared vent 876 of the ducting 875 may significantly reduce complexity/cost associated with gas management with less competition for air used for thermal management of the plurality of electrochemical cells 861. Further, or instead, as also compared to sweeping oxyhydrogen from the respective headspace of each of a plurality of electrochemical cells, venting oxyhydrogen from the plurality of electrochemical cells 861 into the shared vent 876 for dilution in the shared vent 876 may reduce the amount of mist (e.g., KOH mist) entrained in gas exhausted from the system 872 to an ambient environment.

In certain implementations, the system 872 for gas management may further or instead include a plurality of risers 878 each defining a respective cell vent 879. The respective headspace 874 of each one of the plurality of electrochemical cells 861 may be fluidically coupled to the shared vent 876 via at least one cell vent 879 of the plurality of risers 878. The plurality of risers 878 may provide a flow restriction and/or a non-linear flow path from the respective headspace 874 to the shared vent 876 as may be useful for reducing the likelihood of unwanted liquid (e.g., mist) from moving into the shared vent 876 from the respective headspace 874. While each respective headspace 874 may exhaust to a single instance of one of the plurality of risers 878, it shall be appreciated that the respective headspace 874 of each of one of the plurality of electrochemical cells 861 may exhaust to the shared vent 876 via more than one instance of the plurality of risers 878.

In some instances, the system 872 may include at least one instance of a fan 880 in fluid communication with the shared vent 876, with the fan 880 operable to move gas along the shared vent 876 and out of the ducting 875 via the outlet region 877. It shall be appreciated that operation of the fan 880 to move gas along the shared vent 876 may reduce the amount of time that that oxyhydrogen mixture remains in the shared vent 876 before being exhausted to an ambient environment through the outlet region 877. Further, or instead, in instances in which operation of the fan 880 moves air through the shared vent 876, the fan 880 may dilute the oxyhydrogen mixture with air, thus reducing the likelihood of explosion of the oxyhydrogen mixture relative to otherwise identical conditions without dilution of the oxyhydrogen mixture with ambient air.

In general, the fan 880 may disposed in any one more of various positions relative to the shared vent 876 with the fan 880 in fluid communication with the shared vent 876. As an example, the fan 880 may be disposed in the shared vent 876, as may be useful for using the ducting 875 to provide protection and support for the fan 880. Additionally, or alternatively, the fan 880 disposed in the shared vent 876 may facilitate making efficient use of power provided to the fan 880 to move gas through the shared vent 876. In some examples, the fan 880 may be supported by the ducting 875 at the outlet region 877 defined by the ducting 875, as may be useful for providing access to the fan 880 for repair/replacement while making efficient use of power to the fan 880 to move gas through the shared vent 876.

In certain implementations, the fan 880 may be oriented relative to the shared vent 876 such that the fan 880 is operable to form negative pressure in the shared vent 876 relative to ambient air pressure at the outlet region 877 of the ducting 875. As compared to positive pressure in the shared vent 876, the fan 880 operable to form negative pressure in the shared vent 876 may be useful for reducing the likelihood of the oxyhydrogen mixture inadvertently (e.g., via a leak) moving out of the shared vent 876. That is, the fan 880 operable to form negative pressure in the shared vent 876 may reduce the likelihood that an unsafe concentration of hydrogen may form outside of the shared vent 876. Further, or instead, given that the fan 880 operable to form negative pressure in the shared vent 876 pulls gas from the shared vent 876 to exhaust the gas to an ambient environment via the outlet region 877, the fan 880 may be explosion-proof rated. In the context of the fan 880, the term “explosion-proof” shall be understood to include any fan having a housing that contains any explosion originating from within the housing and prevents and sparks from exiting the housing. Thus, it shall be appreciated instances in which the fan 880 has an explosion-proof rating may reduce the likelihood that the fan 880 itself may serve as an ignition source for an ignitable mixture of oxyhydrogen (or other ignitable mixture) moving through the fan 880 with the fan 880 in operation.

In some implementations, the system 872 may include a plurality of instances of the fan 880 to provide backup redundancy in the system 872. As an example, the system 872 may include a first instance and a second instance of the fan 880, which is useful for reducing the likelihood of an accumulation of a high concentration in the shared vent 876 in the event of failure of one instance of the fan 880. Continuing with this example, the first instance of the fan 880 and the second instance of the fan 880 may be powered separately from one another (e.g., connected to independent power sources) such that failure of a given power source does not act as a single point of failure in operation of the system 872. That is, in the event of a failure of the power source of the first instance of the fan 880, the second instance of the fan 880 may continue to operate with power from a separate power source. Further, or instead, only one of the first instance or the second instance of the fan 880 may be operable at a time, as may be useful for achieving redundancy while making efficient use of power required for gas management by the system 872.

In certain implementations, the ducting 875 may define an inlet region 881, and the fan 880 may be operable to move air (e.g., from an ambient environment outside of the ducting 875 and the plurality of electrochemical cells 861) into the shared vent 876 via the inlet region 881. For example, the respective headspace 874 of each one of the plurality of electrochemical cells 861 may be in fluid communication with the shared vent 876 along the ducting 875 between the inlet region 881 and the outlet region 877 and, as the fan 880 moves air into the shared vent 876 via the inlet region 881, the air moving through the shared vent 876 may mix with gas moving into the shared vent 876 from the respective headspace 874 of each one of the plurality of electrochemical cells 861 and the mixture of gas may ultimately exit the shared vent 876 via the outlet region 877. In certain instances, the system 872 may include a filter 882 disposed along the inlet region 881 of the ducting, as may be useful for reducing or eliminating moisture, dust, and/or other debris from entering the shared vent 876 to prematurely degrade components of the system 872.

The system 872 may include a controller 883 operable to determine conditions that are unsafe or have an increased likelihood of becoming unsafe and to take one or more corrective actions as described herein. The controller 883 may include a processing unit 884 and storage media 885 (e.g., non-transitory, computer-readable storage media) in electrical communication with one another. The storage media 885 may have stored thereon computer-executable instructions that, when executed by the processing unit 884 carry out any one or more of the various different aspects of methods of gas management described herein.

In certain implementations, the system 872 may include a first hydrogen sensor 886A (e.g., any one or more different types of palladium-based hydrogen sensors or other types of hydrogen sensor known in the art) in electrical communication with the controller 883 (e.g., with the processing unit 884 of the controller 883) arranged to sense hydrogen in the shared vent 876. As described in greater detail below, the controller 883 may be configured to receive a first signal from the first hydrogen sensor 886A and to control speed of the fan 880 based on the first signal received from the first hydrogen sensor 883A. In certain implementations, the first hydrogen sensor 886A may be at least partially disposed in the shared vent 876 between the outlet region 877 of the ducting 875 and the fluidic coupling of the respective headspace 874 of each one of the plurality of electrochemical cells 861 to the shared vent 876 of the ducting 875. Because the first hydrogen sensor 886A in such a position is downstream of the respective headspace 874 of each one of the plurality of electrochemical cells 861 in a direction of air movement being forced through the shared vent 876 by the fan 880, the air moving through the shared vent 876 has collected oxyhydrogen from each one of the plurality of electrochemical cells 861 at this position of the first hydrogen sensor 886A. Thus, this position of the first hydrogen sensor 886A in the shared vent 876 may be more likely to detect a global maximum hydrogen concentration within the shared vent 876 as compared to other positions of hydrogen sensors within the shared vent 876. Stated differently, this position of the first hydrogen sensor 886A may increase the likelihood of detecting excessive levels of hydrogen in the shared vent 876 if such levels exist in the shared vent 876, while using only a single sensor or a limited number of sensors.

In certain implementations, the system 872 may further include a second hydrogen sensor 886B in electrical communication with the controller 883 (e.g., with the processing unit 884). As described in greater detail below, the controller 883 may be further configured to receive a second signal from the second hydrogen sensor 886B and to control speed of the fan 880 based on the first signal and the second signal. As an example, the first hydrogen sensor 886A and the second hydrogen sensor 886B may be arranged to measured signals indicative of hydrogen concentration in the same or nearly the same position of the shared vent 876, as may be useful for providing redundancy in the event that one of the hydrogen sensors fails or loses communication with the controller 883. As another example, the second hydrogen sensor 886B may be arranged to measure a signal indicative of hydrogen concentration at a position in shared vent 876 away from the measurement made by the first hydrogen sensor 886A, as may be useful for determining certain anomalous conditions resulting in an unusual concentration gradient of hydrogen in the shared vent 876. In such instances, the controller 883 may initiate one or more corrective actions based on the highest of the first signal and the second signal.

In certain implementations, the system 872 may include an enclosure 887, as may be useful for storing and/or shipping the system 872 with little or no need for specialized equipment and/or assembly at the point of use of the system 872. In particular, the enclosure 887 may define an intake opening 888A, an exhaust opening 888B, and a chamber 889, with the intake opening 888A and the exhaust opening 888B in fluid communication with one another via an environment of the chamber. The plurality of electrochemical cells 861 and the manifold 873 may be disposed in the environment of the chamber 889 with the respective headspace 874 of each one of the plurality of the electrochemical cells 861 and the shared vent 876 of the ducting 875 fluidically isolated from the environment of the chamber 889, and the outlet region 877 of the ducting 875 may be in fluid communication with an ambient environment outside of the enclosure 887. That is, under normal operating conditions, the enclosure 887 protects the plurality of electrochemical cells 861 and the manifold 873 (e.g., from degradation associated with weather) without an accumulation of hydrogen in the environment of the chamber 889.

While the enclosure 887 is useful for packaging the system 872 in a form factor that is amenable to being transport and is additionally, or alternatively, useful for protecting components of the system 872, it shall be appreciated that the environment of the chamber 889 may be associated with certain dangerous or potentially dangerous conditions under anomalous situations in which hydrogen inadvertently collects in the environment of the chamber 889. Accordingly, in some implementations, the system 872 may include a leak sensor 888C (e.g., a hydrogen sensor similar to the first hydrogen sensor 886A and the second hydrogen sensor 886B) arranged to sense hydrogen in the environment of the chamber 889. Continuing with this example, the controller 883 may be in electrical communication with the leak sensor 88C and the controller 883 may be further configured to receive a third signal from the leak sensor 886C and to take one or more corrective actions based at least in part on the third signal of the leak sensor 886C in instances in which the leak sensor 886C detects high amounts of hydrogen in the environment of the chamber 889.

Referring now to FIG. 8C, in certain implementations, a corrective action initiated by the controller 883 based on the third signal from the leak sensor 886C may include using one or more thermal management components that operate to keep the plurality of electrochemical cells 861 under normal operating conditions. For example, the system 872 may include a cooling fan 890A in fluid communication with the environment of the chamber 889 and activatable to pull air into the environment of the chamber 889 via the intake opening 888A and exhaust air from the environment of the chamber 889 via the exhaust opening. That is, while the cooling fan 890A may ordinarily cool the plurality of electrochemical cells 861 under normal operating conditions, the air change resulting from operation of the cooling fan 890A may advantageously remove hydrogen from the environment of the chamber 889 when high concentrations of hydrogen are detected by the leak sensor 886C or under other anomalous conditions (e.g., loss of communication between the leak sensor 886C and the controller 883). As an example, the air change of the environment of the chamber 889 with the cooling fan 890A actuated may be less than about 30 seconds with the cooling fan 890A activated at maximum rated speed, as may be useful for quickly lower hydrogen concentration in the environment of the chamber 889 to restore safe operating conditions.

In certain implementations, the system 872 may include a filter material 890B supported along the intake opening 888A of the enclosure 887. The filter material 890B may be generally useful for reducing the likelihood of ingress of moisture, debris, or other unwanted material into the environment of the chamber 889 as the cooling fan 890A draws air through the filter material 890B and into the environment of the chamber 889. In the context of gas management, such reduction of unwanted material in the environment of the chamber 889 may be useful for reducing the likelihood of certain failure modes (e.g., failure of the cooling fan, failure of communication between the leak sensor 88C and the controller 883, etc.) that may serve as a basis for initiating one or more corrective actions up to and including interruption of operation of the system.

In some implementations, the system 872 may include evaporative media 890C supported along the intake opening 888A of the enclosure 887. Thus, as air moves through the intake opening 888A of the enclosure 887, the evaporative media 890C may evaporate and, in doing so, cools the air entering the environment of the chamber 889. While such cooling is primarily associated with thermal management of the plurality of electrochemical cells 861 under normal operating conditions, it shall be appreciated that the cooling provided by the evaporative media 890C may reduce temperature in the environment of the chamber 889, thus lowering the likelihood of ignition of a hydrogen containing gas mixture in the chamber 889 as compared to the likelihood of ignition at higher temperatures that would otherwise occur in the absence of the evaporative media 890C.

Referring now to FIG. 8D, the system 872 may include an event sensor 891 in some implementations. While various aspects of gas management described herein are prophylactic, the event sensor 891 may detect whether a high pressure event—such as one associated with associated with an explosion—has occurred such that the system 872 should be shut down or otherwise checked to reduce the likelihood of additional pressure events that may be larger than an initial pressure event detectable by the event sensor 891. As an example, the event sensor 891 may include a housing 891A, a film 891B, and a wire 891C. The housing 891A may define a first opening 891D, a second opening 891E, and a volume 891F therebetween. The first opening 891D may be in fluid communication with the shared vent 876, and the film 891B may be disposed in the volume such that the film 891B fluidically isolates the first opening 891D from the second opening 891E in the volume 891F. The second opening 891E may be in fluid communication with an environment outside of the ducting 875 to equalize pressure inside and outside of the event sensor 891. Further, the second opening 891E may be small such that gas will not readily flow out of the second opening 891E if hydrogen-containing gas reaches the second opening 891E as a result of a pressure event in the shared vent 876. The wire 891C may be in electrical communication with a power source and the film 891B to form at least a portion of a closed circuit. At a predetermined pressure difference across the film 891B—that is, on either side of the film 891B, the film may be burstable to switch the closed circuit to an open circuit, with the open circuit triggering an alert and/or other corrective actions in some instances. It shall be appreciated that the predetermined pressure difference across the film 891B may correspond to a pressure difference associated with a rapid pressure rise associated with an explosion. Thus, in some instances, the film 891B may be stainless steel or another highly conductive material and additionally, or alternatively, may have have a burst pressure of about 0.35 atmospheres across the film 891B.

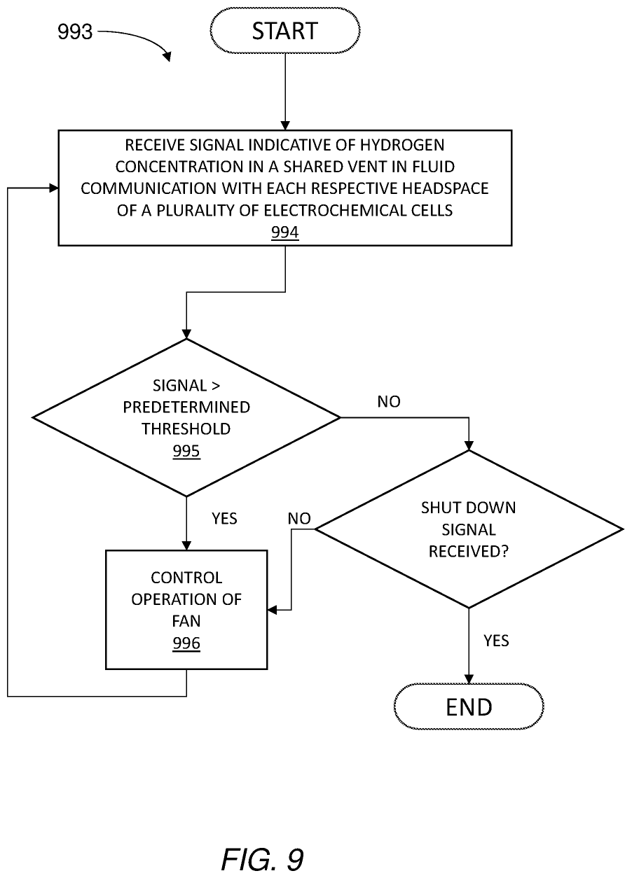

FIG. 9 is a flowchart of an exemplary method 993 of gas management of metal-air batteries. Unless otherwise specified or made clear from the context, it shall be understood that any one or more of various different aspects of the exemplary method 993 may be carried out by the controller 883 (FIG. 8B) in electrical communication with one or more of various different sensors, fans, and/or other components described herein. For example, the storage media 885 (FIG. 8B) may have stored thereon instructions for causing the processing unit 884 (FIG. 8B) to carry out one or more aspects of the exemplary method 993.

As shown in step 994, the exemplary method 993 may include receiving, from each of one or more hydrogen sensors, a respective signal indicative of hydrogen concentration in a shared vent defined by ducting and in fluid communication between each respective headspace of a plurality of electrochemical cells and an outlet defined by the ducting. As an example, the respective signal from at least one of the one or more hydrogen sensors may be indicative of hydrogen concentration in the shared vent upstream of the at least one fan relative to a direction of gas flow through the at least one fan toward the outlet of the ducting. Further, or instead, the respective signal from the at least one of the one or more hydrogen sensors is indicative of hydrogen concentration in the shared vent downstream of fluidic coupling of the headspaces of the electrochemical cells to the shared vent relative to the direction of gas flow through the at least one fan toward the outlet of the ducting.

In certain implementations, receiving the respective signal from the one or more hydrogen sensors may include determining whether each of the one or more hydrogen sensor is operational. For example, the absence of a signal received from a given one of the one or more hydrogen sensors at a time when such a signal may be indicative that the given hydrogen sensor has stopped working and/or has lost communication with the controller. If the sensor is determined to be non-operational, one or more corrective actions may be initiated to reduce the likelihood of an anomalous condition developing while the given hydrogen sensor is non-operational. As an example, at least one fan used to move air through the shared vent of the ducting may be controlled to operate at 100 percent (or another predetermined percentage) of rated operating speed such that a high volumetric flow rate of air may continue to move through the shared vent. While such operation of the fan is generally inefficient under normal operating conditions, it shall be appreciated that operating the fan at high speed in this context is generally done for a short period of time (e.g., until a corrective action can be taken with respect to the non-operational hydrogen sensor.

As shown in step 995, the exemplary method 993 may include comparing the respective signal from each of the one or more hydrogen sensors to at least one predetermined threshold. As an example, the at least one predetermined threshold may correspond to a hydrogen concentration less than the lower flammability limit of hydrogen in air at a predetermined temperature and a predetermined pressure (e.g., at 25° C. at atmospheric pressure). While the at least one predetermined threshold may be a single threshold in some instances, it shall be appreciated that the at least one predetermined threshold may include a first predetermined threshold and a second predetermined threshold, and the second predetermined threshold may be greater than the first predetermined threshold. As an example, the first predetermined threshold and the second predetermined threshold may correspond to a window of hydrogen concentration below the lower flammability limit of hydrogen at the predetermined temperature and the predetermined pressure such that the window may form the basis of closed-loop control of any one or more of the various different components of gas management systems described herein. As an example, the first predetermined threshold may correspond to 12.5% of the lower flammability limit of hydrogen in air at a predetermined temperature and a predetermined temperature while the second predetermined threshold may correspond to 25% of the lower flammability limit of hydrogen in air at the same conditions. These values provide a useful margin of safety relative to the lower flammability limit such that one or more corrective actions may be taken prophylactically—namely, before hydrogen concentration within the shared vent becomes dangerous.

As shown in step 996, the exemplary method 993 may include, based on comparison of the respective signal of each of the one or more hydrogen sensors to the at least one predetermined threshold in step 995, controlling at least one fan in fluid communication with the shared vent and operable to move gas along the shared vent and out of the ducting via the outlet. For example, controlling the at least one fan may include forming vacuum pressure in the shared duct, as may be useful for reducing the likelihood that hydrogen in the shared duct may leak out of the ducting.

Returning to the example in which the at least one predetermined threshold includes a first predetermined threshold and the second predetermined threshold, controlling that at least one fan may include adjusting an operating speed of the at least one fan if the respective signal from any one of the hydrogen sensors is between the first predetermined threshold and the second predetermined threshold. In some implementations, adjusting the operating speed of the at least one fan may include ramping up (e.g., progressively increasing the speed over time) the operating speed of the at least one fan if the respective signal from any of the one or more hydrogen sensors is between the first predetermined threshold and the second predetermined threshold. Continuing with this example, once the respective signal from each of the one or more hydrogen sensors indicates that the hydrogen concentration in the shared vent is below the first predetermined threshold, the at least one fan may be shut off to reduce the amount of power consumed for gas management. Continuing still further with this example, signals from the one or more hydrogen sensor indicating that hydrogen concentration in the shared vent is below the first predetermined threshold and the at least one fan shut off, controlling the at least one fan may include periodically activating the at least one fan at one or more predetermined intervals. Such periodic activation of the at least one fan may move any hydrogen from the shared vent and, further or instead, may provide conditions useful for periodically measuring hydrogen concentration to determine whether additional fan activation is required. It shall be appreciated that, as compared to continuously operating the at least one fan, the periodic activation of the at least one fan under low hydrogen conditions consumes less power.

While certain implementations of gas management have been described, it shall be appreciated that other implementations of gas management are additionally or alternatively possible.

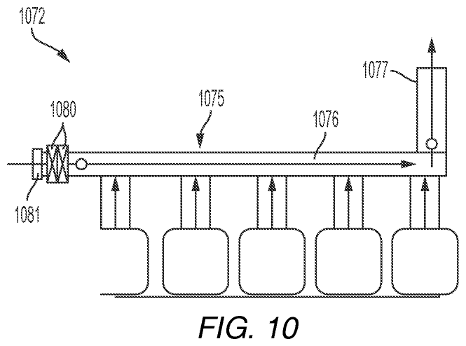

For example, while fans have been described as being arranged to pull air into a shared vent through an inlet in ducting defining the shared vent, other fan arrangements are additionally, or alternatively possible. For example, referring now to FIG. 10, a system 1072 may include at least one instance of a fan 1080 oriented relative to a shared vent 1076 defined by ducting 1075 such that the at least one instance of the fan 1080 is operable to form positive pressure in the shared vent 1076 relative to ambient pressure at an inlet region 1081 of the ducting 1075. That is, the at least one instance of the fan 1080 may be operable to push air through the shared vent 1076 in a direction from the inlet region 1081 toward an outlet region defined by the ducting 1075. In such implementations, the at least one instance of the fan 1080 is located upstream—relative to a direction of air being pushed in the shared vent 1076 from the inlet region 1081 to the outlet region 1077—relative to locations associated with hydrogen accumulation in the shared vent 1076. Accordingly, the at least one instance of the fan 1080 is unlikely to be in the vicinity of accumulated hydrogen and this may translate into cost savings with respect to the type of fan used (e.g., the at least one instance of the fan 1080 may be a fan type that does not have an explosion proof rating).

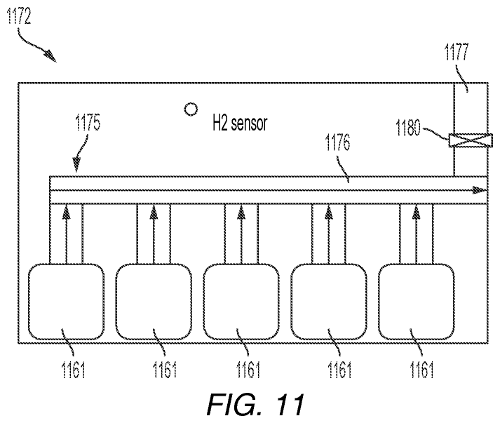

Further or instead, while ducting has been described as including shared vents defining an inlet and an outlet, other approaches are additionally, or alternatively possible. For example, referring now to FIG. 11, a system 1172 may include ducting 1075 defining a shared vent 1176, and the ducting 1075 may be dead ended along the shared vent 1176 such that at least one instance of a fan 1080 pulls gas through the shared vent 1176 in a direction away from fluidic coupling of a plurality of electrochemical cells 1161 toward an outlet region 1177 defined by the shared vent 1176.

Additionally, or alternatively, while systems for gas management have been described as venting oxyhydrogen mixtures, it shall be appreciated that other approaches are additionally or alternatively possible. For example, oxygen and hydrogen may be vented separately from each one of a plurality of electrochemical cells. With oxygen and hydrogen vented separately, the likelihood of an ignitable mixture of hydrogen and oxygen/air decreases. However, such an arrangement requires additional hardware, as compared to techniques described herein for venting oxyhydrogen mixtures. For example, to vent oxygen and hydrogen separately, each one of the electrochemical cells may include a separator disposed between at least one air electrode and a metal electrode. The separator may divide the headspace into a first portion and a second portion fluidically isolated from one another. The first portion of the headspace may be above the metal electrode and in fluid communication with the shared vent of the ducting. The second portion of the headspace may be above the at least one air electrode and in fluid communication with an oxygen vent exhausting to an ambient atmosphere.

The foregoing method descriptions and the process flow diagrams are provided merely as illustrative examples and are not intended to require or imply that the steps of various embodiments should be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular. Herein, “about” may refer to a range of +/−5%.

Further, any step of any embodiment described herein can be used in any other embodiment. The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A system for gas management of metal-air batteries, the system comprising:
a plurality of electrochemical cells, each one of the plurality of electrochemical cells including at least one air electrode, a metal electrode, a vessel, and a liquid electrolyte between the at least one air electrode and the metal electrode in the vessel, each one of the plurality of electrochemical cells defining a respective headspace above the liquid electrolyte in the vessel; and
a manifold including ducting defining a shared vent and an outlet region, the respective headspace of each one of the plurality of electrochemical cells fluidically coupled to the shared vent and in fluid communication with the outlet region of the ducting.

2. The system of claim 1, further comprising a plurality of risers, wherein each one of the plurality of risers defines a respective cell vent, and the respective headspace of each one of the plurality of electrochemical cells is fluidically coupled to the shared vent via at least one cell vent of the plurality of risers.

3. The system of claim 1, further comprising at least one fan in fluid communication with the shared vent, wherein the at least one fan is operable to move gas along the shared vent and out of the ducting via the outlet region.

4. The system of claim 3, wherein the at least one fan is disposed in the shared vent.

5. The system of claim 3, wherein the at least one fan is oriented relative to the shared vent such that the at least one fan is operable to form negative pressure in the shared vent relative to ambient air pressure at the outlet region of the ducting.

6. The system of claim 3, wherein the ducting is dead ended along the shared vent, and the at least one fan pulls gas through the shared vent in a direction away from fluidic coupling of the plurality of electrochemical cells toward the outlet region.

7. The system of claim 3, wherein the ducting defines an inlet region, the respective headspace of each one of the plurality of electrochemical cells is in fluid communication with the shared vent along the ducting between the inlet region and the outlet region, and the at least one fan is operable to move air into the shared vent via the inlet region.

8. The system of claim 3, further comprising a controller and a first hydrogen sensor, wherein the controller is in electrical communication with the at least one fan and the first hydrogen sensor, the at first hydrogen sensor is arranged to sense hydrogen in the shared vent, and the controller is configured to receive a first signal from the first hydrogen sensor and to control speed of the at least one fan based on a first signal received from the first hydrogen sensor.

9. The system of claim 8, wherein the first hydrogen sensor is at least partially disposed in the shared vent between the outlet region of the ducting and the fluidic coupling of the respective headspace of each one of the plurality of electrochemical cells to the shared vent of the ducting.

10. The system of claim 9, further comprising a second hydrogen sensor in electrical communication with the controller, wherein the controller is further configured to receive a second signal from the second hydrogen sensor and to control speed of the at least one fan based on the first signal and the second signal.

11. The system of claim 9, further comprising an enclosure defining an intake opening, an exhaust opening, and a chamber, wherein the intake opening and the exhaust opening are in fluid communication with one another via an environment of the chamber, the plurality of electrochemical cells and the manifold are at least partially disposed in the environment of the chamber with the respective headspace of each one of the electrochemical cells and the shared vent of the ducting fluidically isolated from the environment of the enclosure, and the outlet region of the ducting is in fluid communication with an ambient environment outside of the enclosure.

12. The system of claim 11, further comprising a cooling fan in fluid communication with the environment of the chamber and activatable to pull air into the environment of the chamber via the intake opening and exhaust air from the environment of the chamber via the exhaust opening.

13. The system of claim 12, further comprising evaporative media supported along the intake opening of the enclosure, wherein evaporation of the evaporative media cools air pulled into the environment of the chamber through activation of the cooling fan.

14. The system of claim 11, further comprising a leak sensor arranged to sense hydrogen in the environment of the chamber, wherein the controller is in electrical communication with the leak sensor and the controller is further configured to receive a third signal from the leak sensor and to activate the cooling fan based on the third signal.

15. The system of claim 1, further comprising an event sensor including a housing, a film, and a wire, wherein the housing defines a first opening, a second opening, and a volume therebetween, the first opening is in fluid communication with the shared vent of the ducting, the film is disposed in the volume and fluidically isolates the first opening from the second opening in the volume, the wire is in electrical communication with a power source and the film to form at least a portion of a closed circuit and, at a predetermined pressure difference across the film, the film is burstable to switch the closed circuit to an open circuit.

16. The system of claim 1, wherein the plurality of electrochemical cells includes iron-air type battery cells, zinc-air type battery cells, lithium-air battery cells, or a combination thereof.

17. A method of gas management of metal-air batteries, the method comprising:
receiving, from each of one or more hydrogen sensors, a respective signal indicative of hydrogen concentration in a shared vent defined by ducting and in fluid communication between each respective headspace of a plurality of electrochemical cells and an outlet region defined by the ducting;
comparing the respective signal from each of the one or more hydrogen sensors to at least one predetermined threshold; and
based on comparison of the respective signal of each of the one or more hydrogen sensors to the at least one predetermined threshold, controlling at least one fan in fluid communication with the shared vent and operable to move gas along the shared vent and out of the ducting via the outlet region.

18. The method of claim 17, wherein the at least one predetermined threshold corresponds to hydrogen concentration less than the lower flammability limit of hydrogen in air at a predetermined temperature and a predetermined pressure.

19. The method of claim 17, wherein the respective signal from at least one of the one or more hydrogen sensors is indicative of hydrogen concentration in the shared vent upstream of the at least one fan relative to a direction of gas flow through the at least one fan toward the outlet region of the ducting.

20. The method of claim 17, wherein receiving the respective signal from the one or more hydrogen sensors includes determining whether each of the one or more hydrogen sensors is operational, and controlling the at least one fan includes operating the at least one fan at 100 percent of rated operating speed if each of the one or more hydrogen sensors is determined to be non-operational.
